(19) United States
(12) Patent Application Publication
(10) Pub. No.: US 2023/0024360 A1
(43) Pub. Date: Jan. 26, 2023

(54) ANTI-BACKBENDING IDLER

(71) Applicant: Caterpillar Inc., Peoria, IL (US)

(72) Inventors: David J. Hakes, Princeville, IL (US); Eric James Johannsen, Washington, IL (US)

(73) Assignee: Caterpillar Inc., Peoria, IL (US)

(21) Appl. No.: 17/382,845

(22) Filed: Jul. 22, 2021

(51) Int. Cl. B62D 55/14; B62D 55/21; B62D 55/20

(52) U.S. Cl. CPC B62D 55/14; B62D 55/21; B62D 55/202

(57) ABSTRACT

An idler assembly includes a hub defining an axis of rotation, a radial direction, and a circumferential direction, and a stepped circumferential surface having a first radially inner face, and a radially outer circumferential surface, forming a raised ridge portion. The radially outer circumferential surface defines an outer diameter, and the first radially inner face defines an inner diameter. A ratio of the outer diameter to the inner diameter ranges from 1.06 to 1.28.

### TECHNICAL FIELD

The present disclosure relates to an idler used to guide a track chain assembly of an endless undercarriage drive employed by earth moving, construction and mining equipment and the like. Specifically, the present disclosure relates to such an idler that is constructed in a manner to reduce the likelihood of “backbending” of the track chain assembly.

### BACKGROUND

Earth moving, construction and mining equipment and the like are often used in rough, off-road terrain. These machines often employ an endless drive with track shoes that is better able to propel the machines in such environments over obstacles and uneven terrain, etc. The track chain assemblies, which include shoes, are held together by a series of interconnected track links, pins and bushings that are supported on the drive sprocket, idler and support rollers of the machine. The drive sprocket, is so called, as it may drive or convey power to the track chain assembly, causing it to revolve about the idler wheels, resulting in linear motion of the machine. The idler wheels provide guidance to the track chain assembly, helping to keep the track chain assembly on the undercarriage.

As shown in FIG. 1, the machine 10 may include a body 14, with a track system 12 attached thereto, and also has a cab (not shown) to house a machine operator. The machine may also include an implement 16 such as a blade or a bucket, etc. A control system can be housed in the cab that can be adapted to allow a machine operator to manipulate and articulate the implement 16 for digging, excavating, or any other suitable application.

Its undercarriage structure includes a supporting structure that supports the track system 12 utilized for movement of the machine 10. The track system 12 may include first and second track roller frame assemblies 18, which are spaced from and adjacent respective first and second sides of the undercarriage assembly. It will be appreciated that only one of the track roller frame assemblies 18 is visible in FIG. 1. An idler 20 as well as a plurality of track rollers 22 may be also be provided.

Heavy loads are often exerted on the idler, which is typically round, that contacts the flat surfaces of the links of the track chain assembly. Also, heavy loads may be exerted on the track chain assembly by the sprocket as it attempts to propel the machine through harsh terrain. This may lead to “backbending” of the track chain assembly (see lines 1A that show backbending as opposed to lines 1B that show a desired straight track chain path in FIG. 1) where the track links bend at a joint at the bottom of the track chain assembly where contact with the ground is made.

This may lead to damage of the track chain assembly or other parts of the undercarriage of the machine, leading to undesirable downtime for the machine.

### SUMMARY

An idler assembly according to an embodiment of the present disclosure may include a hub defining an axis of rotation, a radial direction, and a circumferential direction, and a stepped circumferential surface having a first radially inner face, and a radially outer circumferential surface, forming a raised ridge portion. The radially outer circumferential surface defines an outer diameter, and the first radially inner face defines an inner diameter, and a ratio of the outer diameter to the inner diameter ranges from 1.06 to 1.28.

A track chain assembly according to an embodiment of the present disclosure may comprise a plurality of track pins and track bushings disposed about the track pins, and a plurality of track links that are connected to each other by either a track pin or a track bushing, each of the plurality of track links defining a rail surface. At least one track link of the plurality of track links may define a plurality of apertures for receiving a track pin or bushing, and at least one of the plurality of track bushings may define an outer diameter, and a minimum distance to the rail surface of at least one of the plurality of track links. A ratio of the outer diameter to the minimum distance may range from 1.53 to 1.85.

An undercarriage assembly according to an embodiment of the present disclosure may comprise an idler including a hub defining an axis of rotation, a radial direction, and a circumferential direction, as well as a stepped circumferential surface having a first radially inner face, and a radially outer circumferential surface, forming a raised ridge portion. The undercarriage assembly may further include a track chain assembly including a plurality of track pins and track bushings disposed about the track pins, and a plurality of track links that are connected to each other by either a track pin or a track bushing, each of the plurality of track links defining a rail surface. At least one of the plurality of track bushings defines an outer diameter that contacts the radially outer circumferential surface, and at least one of the plurality of the rail surfaces contacts the first radially inner face of the idler.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a side-view of a machine such a bulldozer that illustrates the problem of “backbending” occurring to a track chain assembly as is known in the prior art.

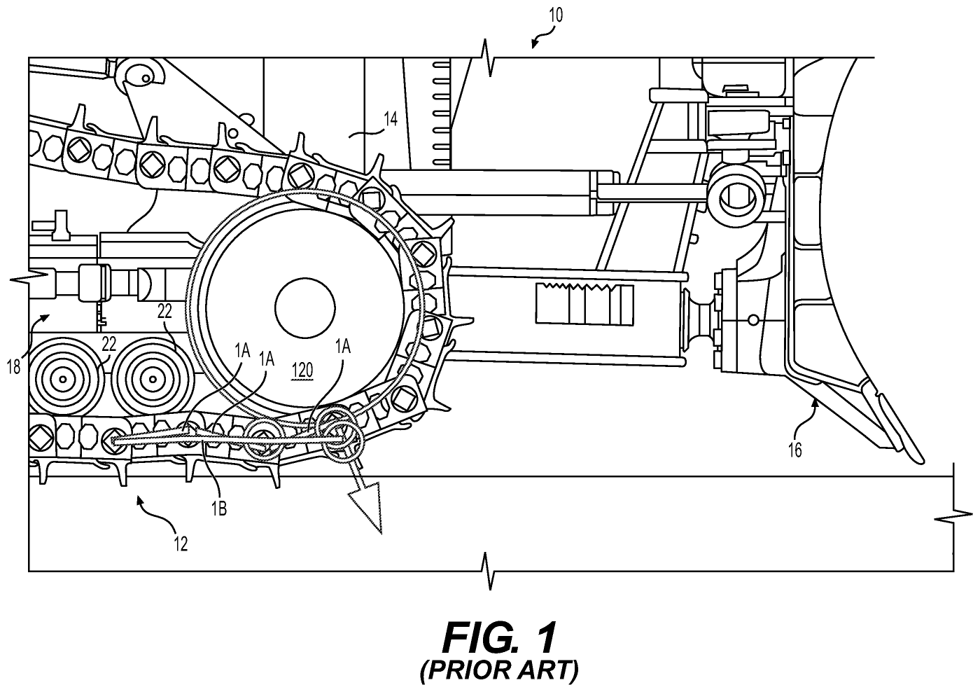

FIG. 2 is an enlarged view showing an idler mating with a track chain assembly similar to FIG. 1 in a manner known in the prior art to experience backbending.

FIG. 3 is a side view of an idler and track chain assembly constructed according to an embodiment of the present disclosure that may reduce the likelihood of backbending from occurring.

FIG. 4 is an enlarged is an enlarged perspective of the idler and track chain assembly of FIG. 3, with a set of links removed to more clearly show the idler contacting the bushings of the track chain assembly.

FIG. 5 is a perspective view of an idler assembly similar or identical to the idler disclosed in FIG. 3 shown in isolation.

FIG. 6 is a side cross-sectional view of the axle and upper portion of the idler assembly of FIG. 5.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

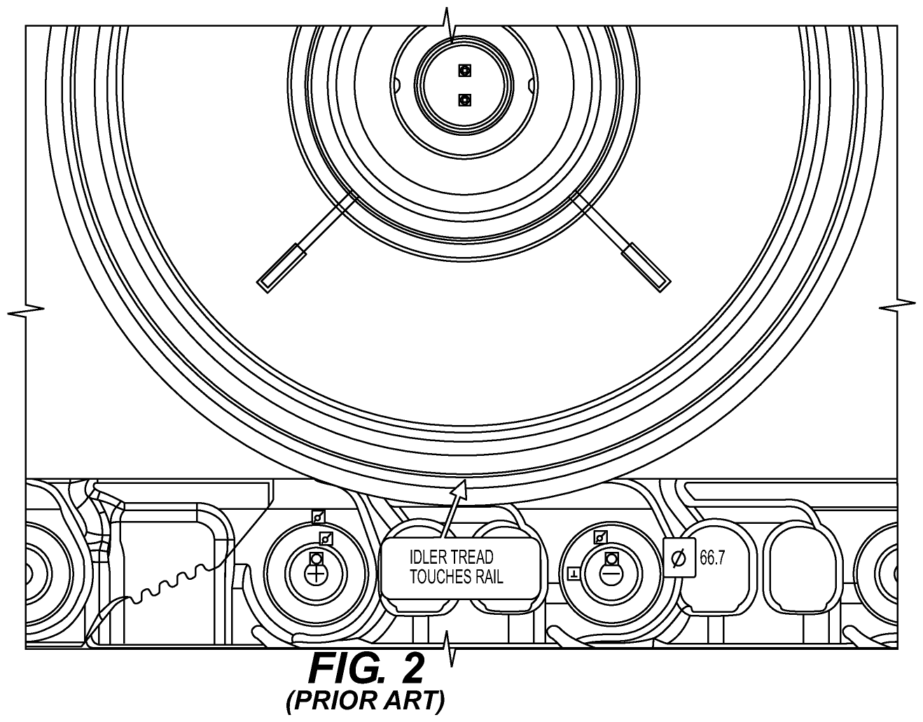

Looking at FIG. 2, the inventors of the present disclosure have discovered that prior art undercarriages have an idler that contacts one of the bushing of the track chain assembly or the rail surface of the track link, but not both. This instability leads to an increased risk of backbending.

Momentarily, an undercarriage associated with a track type work machine that may help prevent the problem of backbending will be disclosed. The idler may include a middle-raised portion and two end portions. Further, the middle-raised portion may be configured to contact a bushing of a cartridge joint of a machine track chain, while the end portions may be configured to contact links of the machine track chain, thereby limiting the possibility of backbend of a track joint of the undercarriage.

While the arrangement is illustrated in connection with a bulldozer, the arrangement disclosed herein has universal applicability in various other types of machines commonly employ track systems, as opposed to wheels. The term “machine” may refer to any machine that performs some type of operation associated with an industry such as mining, earth moving or construction, or any other industry known in the art. For example, the machine may be an excavator, a wheel loader, a cable shovel, a track type tractor, a hydraulic mining shovel, or dragline or the like. Moreover, one or more implements may be connected to the machine. Such implements may be utilized for a variety of tasks, including, for example, lifting and loading.

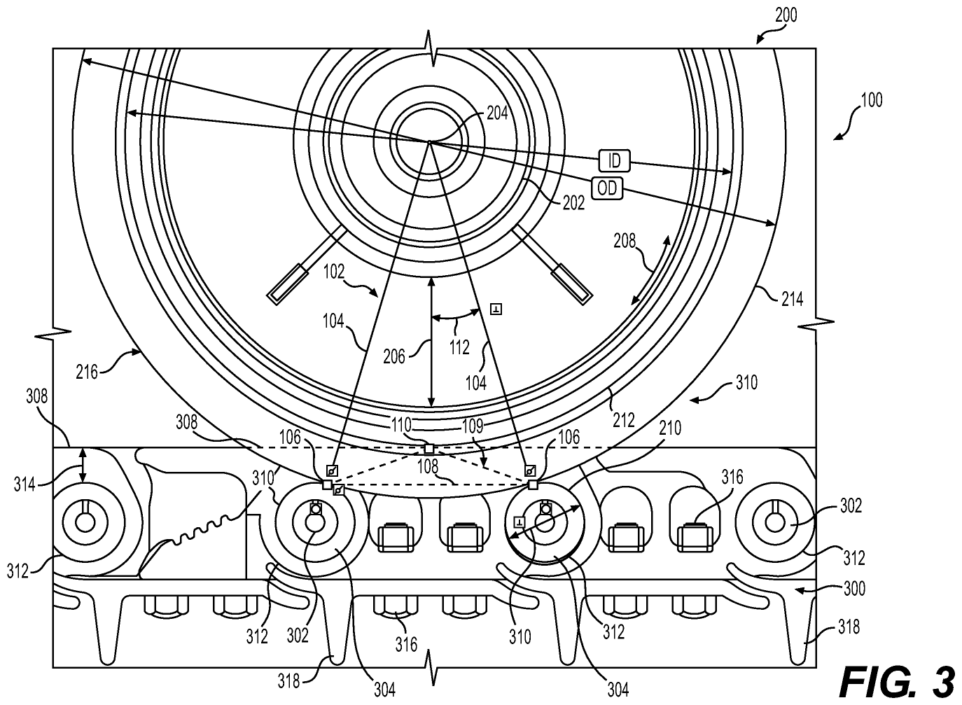

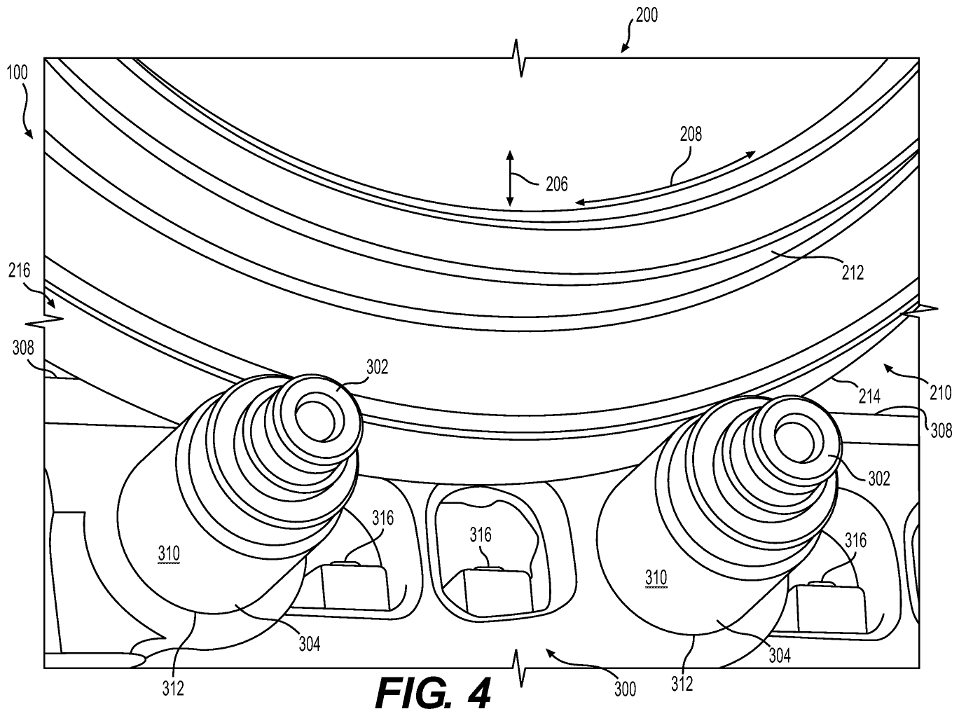

Turning to FIGS. 3 and 4, such an undercarriage assembly 100 that is less prone to backbending may comprise an idler 200 that includes a hub 202 defining an axis of rotation 204, a radial direction 206, and a circumferential direction 206. A stepped circumferential surface 210 may be provided, having a first radially inner face 212, and a radially outer circumferential surface 214. This arrangement may form a raised ridge portion 216.

The undercarriage assembly may further include a track chain assembly 300 that includes a plurality of track pins 302 and track bushings 304 disposed about the track pins. Also, a plurality of track links 306 that are connected to each other by either a track pin or a track bushing. Each of the plurality of track links 306 may define a rail surface 308.

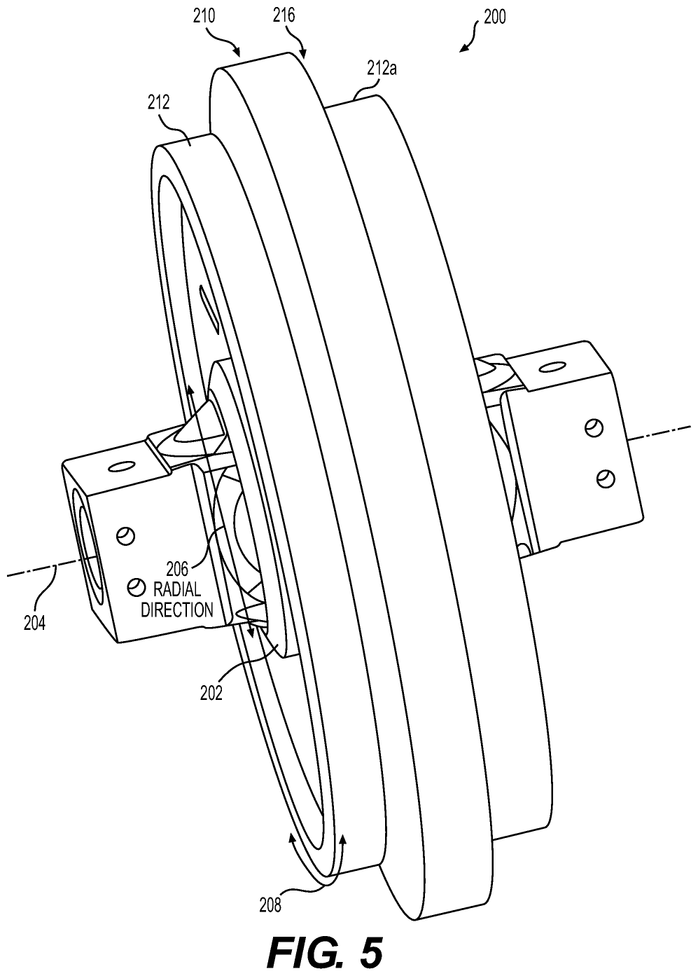

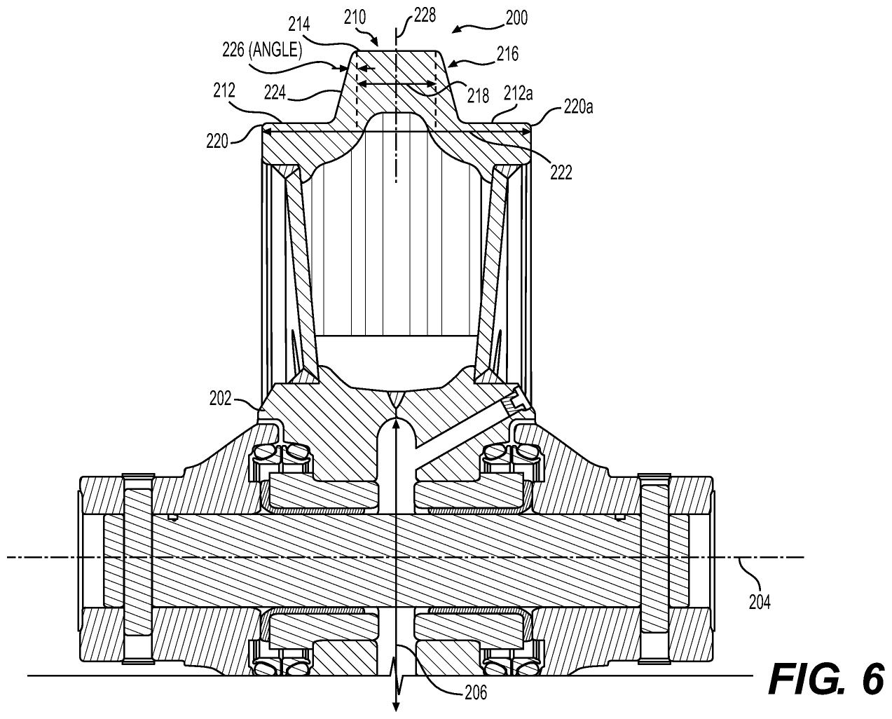

Also, at least one of the plurality of track bushings 304 may define an outer diameter 310 that is configured to contact the radially outer circumferential surface 214, and at least one of the plurality of the rail surfaces 308 is configured to contact the first radially inner face 212 of the idler 200. More particularly, all of the rail surfaces may be configured to contact both the first radially inner face 212 as well as the second radially inner face 212a (both 212 and 212a are shown in FIGS. 5 and 6) as they pass under the idler.

Either contact may occur intermittently, or substantially simultaneously, etc. as will be discussed in more detail later herein. The idler 200 in fact may contact both the outer diameter 310 of the bushing 304, and the rail surface 308 simultaneously as shown in FIG. 3. This may provide enough stability for both the track chain assembly as well as the idler to help prevent backbending.

In order to prevent wear issues becoming more frequent at the price of decreasing the likelihood of backbending, the outer diameter 310 of the track bushing 304 may be harder than at least a portion of the raised ridge portion 216 of the idler 200. This may not be the case for other embodiments of the present disclosure.

In such an embodiment, the outer diameter 310 of the track bushing 304 that is designed to contact the radially outer circumferential surface 214 of the idler 200 may have a hardness that ranges from 52.0 to 62.0 Rockwell Scale C, while the part of the raised ridge portion 216 of the idler 200 that is designed to be contacted (e.g., the entire radially outer circumferential surface 214) may have a hardness that ranges from 45.0 to 55.0 Rockwell Scale C. Other values of the hardness and difference therebetween are possible in other embodiments of the present disclosure.

This change of surface properties between the bushing and the idler may help to ameliorate or prevent wear issues from occurring between the idler and the bushing. Also, different types of surface coatings and surface treatments may be applied to the idler and/or bushing to address wear issues.

With continued reference to FIGS. 3 and 4, a track chain assembly 300 that may be supplied as a replacement or retrofit in the field will now be described.

Such a track chain assembly 300 may comprise a plurality of track pins 302 and track bushings 304 disposed about the track pins 30, as well as a plurality of track links 306 that are connected to each other by either a track pin 302 or a track bushing 304. Each of the plurality of track links 306 may define a rail surface 308 (so called since the rollers and idlers roll on this surface).

Each track link 306 of the plurality of track links may define a plurality of apertures 312 for receiving a track pin 302 or bushing 304 At least one of the plurality of track bushings 304 may define an outer diameter 310. A minimum distance 314 may be measured from the outer diameter 310 to the rail surface 308 of at least one of the plurality of track links. A ratio of the outer diameter 310 to the minimum distance 314 may range from 1.53 to 1.85 in some embodiments of the present disclosure. In such embodiments, the outer diameter 310 may range from range from 66.0 mm to 67.4 mm (e.g., about 66.7 mm), and/or its hardness may range from 52.0 to 62.0 Rockwell Scale C. Other ranges are possible in other embodiments of the present disclosure.

As best seen in FIG. 3, the track chain assembly 300 may further comprise a plurality of track fasteners 316, and a plurality of track shoes 318 that are attached to the track links 306 via the track fasteners 316. Other forms of attachment are possible in other embodiments of the present disclosure.

Next, an idler assembly (e.g., see 200) that may be provided as a replacement or retrofit in the will now be discussed in further detail with reference to FIGS. 3 thru 6.

The idler assembly may comprise a hub 202 defining an axis of rotation 204, a radial direction 206, and a circumferential direction 208. Also, the idler may have a stepped circumferential surface 210 having a first radially inner face 212 (may be cylindrical, slightly conical, or slightly arcuate), and a radially outer circumferential surface 214 (may be cylindrical, slightly arcuate or slightly conical), forming a raised ridge portion 216.

As best seen in FIG. 3, the radially outer circumferential surface 214 may define an outer diameter OD, whereas the first radially inner face 212 may define an inner diameter ID. In some embodiments of the present disclosure, a ratio of the outer diameter OD to the inner diameter ID may range from 1.06 to 1.28 (e.g., about 1.16).

In such a case, the outer diameter OD may range from 588.2 mm to 590.2 mm (e.g., about 589.2 mm), while the inner diameter may range from 505.0 mm to 507.0 mm. Put another way, a difference of the outer diameter OD minus the inner diameter ID may range from 82.0 mm to 84.0 mm (e.g., about 83.0 mm) in some embodiments of the present disclosure. Any of these ratios or dimensional ranges may be altered in other embodiments of the present application to suit a particular application.

For example, in another embodiment the inner diameter may range from 506.0 mm to 510.0 mm, while the outer diameter may range from 568.0 mm to 572.0 mm. In yet another embodiment, the inner diameter may range from 554.0 mm to 558.0 mm, while the outer diameter may range from 623.0 mm to 629.0 mm.

Turning now to FIGS. 5 and 6, it can be seen that the stepped circumferential surface 210 may further include a second radially inner face 212a that is coextensive with the first radially inner face 212 (e.g., 212 and 212a would be the same surface if not interrupted by the raised ridge portion 216). So, both surfaces may have essentially the same inner diameter. This may not the be case in other embodiments of the present disclosure.

FIG. 6 illustrates that the radially outer circumferential surface 214 may define a radially outer axial dimension 218 of the raised ridge portion 216. Similarly, the first radially inner face 212 may define a first axial extremity 220 of the stepped circumferential surface 210, while the second radially inner face 212a may define a second axial extremity 220a of the stepped circumferential surface 210. A radially inner axial dimension 222 spans axially from the first axial extremity 220 to the second axial extremity 220a, and a ratio of the radially inner axial dimension 222 to the radially outer axial dimension 218 may range from 2.93 to 3.54 in some embodiments of the present disclosure. In such a case, the radially outer axial dimension 218 may range from 45.8 mm to 47.8 mm. Other ratios and dimensional ranges are possible depending on the application of the idler, etc.

Moreover, the stepped circumferential surface 210 may include a first sloped surface 224 that extends from the first radially inner face 212 to the radially outer circumferential surface 214, forming a first sloped angle 226 with the radial direction 206 at an intersection between the radially outer circumferential surface 214, and the first sloped surface 226. The first sloped angle 226 may range from 15.0 degrees to 25.0 degrees in some embodiments of the present disclosure, or may be omitted in other embodiments, etc.

Also, the stepped circumferential surface 210 may define a plane of symmetry 228 (may also be a midplane) that is perpendicular to the axis of rotation 204.

As alluded to earlier herein, at least a part of the raised ridge portion 216 may define a hardness that ranges from 45.0 to 55.0 Rockwell Scale C. Alternatively, or in addition to this hardening, various surface coatings such as nitride or surface treatments such as carburization, etc. may be applied to the raised ridge portion.

Any of the aforementioned features may be differently configured or dimensioned than what has been specifically described herein in various embodiments of the present disclosure.

For many embodiments, the idler components such as the outer rim forming the stepped circumferential surface and/or hub may be cast using iron, grey-iron, steel or other suitable materials. Other manufacturing processes may be used such as any type of machining, forging, etc. For example, steel or “tough steel” may be used to create the step circumferential surface. Idler components may also be coated, heat treated, etc. to provide suitable characteristics for various applications.

### INDUSTRIAL APPLICABILITY

In practice, an idler assembly, an idler component, a track chain assembly, and an undercarriage assembly according to any embodiment described herein may be sold, bought, manufactured or otherwise obtained in an OEM (original equipment manufacturer) or after-market context.

The various embodiments of the idler and track chain assembly may help to provide more stability to the track chain assembly and/or idler, reducing the likelihood of backbending from occurring. Also, these embodiments may be scaled up or down, or adjusted dimensionally to accommodate different styles of undercarriages used on different machines.

More specifically, FIG. 3 illustrates that a first isosceles triangle 102 may be formed by two radial lines 104 extending from the axis of rotation 204 to the points 106 of tangential contact between the idler 200 and the bushings 304, and an imaginary base line 108 drawn from one point 106 of tangential contact to the other. A second isosceles triangle 109 (may be an equilateral triangle or nearly so in some embodiments) may form a very stable structure since three points of contact are made between the track chain assembly 300 and the idler 200 (the third point 110 being at the interface between the rail surface 308 and the radially inner face 212 of the idler 200). In some embodiments, the first isosceles triangle may form an angle bisector 112 that ranges from 15.0 degrees to 20.0 degrees (e.g., about 17.5 degrees).

It is to be understood that the second isosceles triangle may actually provide some clearance to prevent potential binding of the track chain. For example, the lower two contact points may be positioned at least 1.0 mm to 5.0 mm lower than shown, etc.

It is contemplated that as the angle bisector decreases, more stability may be provided. It can be appreciated that these three points of contact exist simultaneously, but only intermittently as the track chain assembly continues to move laterally with respect to the idler. As one bushing nears being directly vertically underneath the axis of rotation, the rail surface is no longer in contact with the idler. Eventually, the bushing passes this bottom position until the track chain rises up again and makes three point contact. Decreasing the angle bisector increases the frequency of three point contact, providing more stability. However, attachment points for the shoes, and the overall cost of the track chain assembly may limit the lower bounds of the bisector angle.

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. An idler assembly comprising:
a hub defining an axis of rotation, a radial direction, and a circumferential direction; and
a stepped circumferential surface having a first radially inner face, and a radially outer circumferential surface, forming a raised ridge portion;
wherein the radially outer circumferential surface defines an outer diameter, the first radially inner face defines an inner diameter, and a ratio of the outer diameter to the inner diameter ranges from 1.06 to 1.28.

2. The idler assembly of claim 1, wherein the outer diameter ranges from 588.2 mm to 590.2 mm, or 568.0 mm to 572.0 mm, or 623.0 mm to 629.0 mm.

3. The idler assembly of claim 1, wherein the inner diameter ranges from 505.0 mm to 507.0 mm, or 506.0 mm to 510.0 mm, or 554.0 mm to 558.0 mm.

4. The idler assembly of claim 1, wherein the stepped circumferential surface further includes a second radially inner face that is coextensive with the first radially inner face.

5. The idler assembly of claim 1, wherein a difference of the outer diameter minus the inner diameter ranges from 82.0 mm to 84.0 mm.

6. The idler assembly of claim 4, wherein the radially outer circumferential surface defines a radially outer axial dimension of the raised ridge portion, the first radially inner face defines a first axial extremity of the stepped circumferential surface while the second radially inner face defines a second axial extremity of the stepped circumferential surface, a radially inner axial dimension that spans axially from the first axial extremity to the second axial extremity, and a ratio of the radially inner axial dimension to the radially outer axial dimension ranges from 2.93 to 3.54.

7. The idler assembly of claim 6, wherein the radially outer axial dimension ranges from 45.8 mm to 47.8 mm.

8. The idler assembly of claim 7, wherein the stepped circumferential surface includes a first sloped surface that extends from the first radially inner face to the radially outer circumferential surface, forming a first sloped angle with the radial direction at an intersection between the radially outer circumferential surface and the first sloped surface.

9. The idler assembly of claim 8, wherein the first sloped angle ranges from 15.0 degrees to 25.0 degrees.

10. The idler assembly of claim 8, wherein the stepped circumferential surface defines a plane of symmetry that is perpendicular to the axis of rotation.

11. The idler assembly of claim 1, wherein at least a part of the raised ridge portion defines a hardness that ranges from 45.0 to 55.0 Rockwell Scale C.

12. A track chain assembly comprising:
a plurality of track pins and track bushings disposed about the track pins; and
a plurality of track links that are connected to each other by either a track pin or a track bushing, each of the plurality of track links defining a rail surface;
wherein each track link of the plurality of track links defines a plurality of apertures for receiving a track pin or bushing, and at least one of the plurality of track bushings defines an outer diameter, and a minimum distance to the rail surface of at least one of the plurality of track links, and a ratio of the outer diameter to the minimum distance ranges from 1.53 to 1.85.

13. The track chain assembly of claim 12, wherein the outer diameter ranges from 66.0 mm to 67.4 mm, or from 60.0 mm to 61.4 mm, or from 53.3 mm to 54.7 mm.

14. The track chain assembly of claim 12, further comprising:
a plurality of track fasteners; and
a plurality of track shoes attached to the track links via the track fasteners.

15. The track chain assembly of claim 12, wherein the outer diameter of the bushing has a hardness that ranges from 52.0 to 62.0 Rockwell Scale C.

16. An undercarriage assembly comprising:
an idler including
a hub defining an axis of rotation, a radial direction, and a circumferential direction; and
a stepped circumferential surface having a first radially inner face, and a radially outer circumferential surface, forming a raised ridge portion; and
track chain assembly including
a plurality of track pins and track bushings disposed about the track pins; and
a plurality of track links that are connected to each other by either a track pin or a track bushing, each of the plurality of track links defining a rail surface;
wherein at least one of the plurality of track bushings defines an outer diameter that contacts the radially outer circumferential surface, and at least one of the plurality of the rail surfaces contacts the first radially inner face.

17. The undercarriage assembly of claim 16, wherein the outer diameter of the track bushing that contacts the radially outer circumferential surface is harder than at least a portion of the raised ridge portion.

18. The undercarriage assembly of claim 17, wherein the outer diameter of the track bushing that contacts the radially outer circumferential surfaces has a hardness that ranges from 52.0 to 62.0 Rockwell Scale C.

19. The undercarriage assembly of claim 17, wherein the portion of the raised ridge has a hardness that ranges from 45.0 to 55.0 Rockwell Scale C.

20. The undercarriage assembly of claim 16, wherein the idler contacts both the outer diameter of the bushing and the rail surface simultaneously.
